(19) United States
(12) Patent Application Publication
(10) Pub. No.: US 2007/0137954 A1
(43) Pub. Date: Jun. 21, 2007

(54) Inertial actuator

(76) Inventors: Stephen John Elliott, England (GB); Luca Benassi, England (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/582,194

(22) PCT Filed: Dec. 14, 2004
(86) PCT No.: PCT/GB04/05216

§ 371 Date: Feb. 5, 2007

(30) Foreign Application Priority Data
Dec. 17, 2003 (GB) 0329206.7

(51) Int. Cl. F16F 9/53

(52) U.S. Cl. 188/267.2

(57) ABSTRACT

An inertial actuator assembly comprises an actuator chassis adapted to be secured in use to a structure subject in use to external vibration forces, a proof mass (mₐ) supported with respect to the chassis by a proof mass resilient means, and a force generating transducer means acting between the chassis and the proof mass for subjecting in use the proof mass to a force (fₐ) applied relative to the chassis, a controller arranged to control in use the excitation of the transducer means, wherein the assembly comprises a feedback means H(jω) responsive to a measurement of the displacement (x) of the proof mass relative to the chassis, the controller being arranged to modify the excitation of the force generating transducer means in response to a feedback signal from the feedback means. The feedback signal may be proportional to the displacement, the integral of the displacement, the derivative of the displacement, or to any combination of these.

The present invention relates to inertial actuators, and in particular to their use in active vibration control systems.

### INTRODUCTION

Vibration and noise occur in most machines, structures and dynamic systems. This leads to many undesirable consequences such as degraded performance, structural fatigue, decreased reliability, and human discomfort. There are two main classes of noise and vibration isolation systems which aim to reduce the level of noise and vibration induced by a mechanical structure: passive vibration control and active vibration control.

Passive vibration control involves the use of a resilient mount to isolate a structure from another structure which is vibrating. However, with such passive mounts there is a trade off between low and high frequency performance, with the mount reducing vibrations at low frequencies, but reducing isolation at high frequencies.

Active isolation systems such as Skyhook Damping may be used to achieve a more satisfactory compromise. These cause an actuator to generate a force to compensate for the vibrations and so reduce their transmission to the structure under control. This works well with reactive actuators, but because these need to react off a base structure they can be difficult to implement and are prone to displacement by horizontal forces. Inertial actuators are preferable since they can be directly installed on a vibrating structure. In practice, however, active damping using an inertial actuator is only semi-stable and vibration isolation at low frequencies is difficult to achieve due to the system's instability.

It has been shown that in order to implement stable skyhook damping with an inertial actuator, the natural frequency of the actuator must be below the first resonant frequency of the structure under control and the actuator resonance should be well damped [4]. In practice this is difficult to achieve as low resonant frequencies correspond to mounts which are dynamically ‘soft’. These are prone to ‘sag’ under a static acceleration such as gravity, reducing the efficiency of the actuator.

The present invention seeks to substantially overcome the deficiencies inherent in present vibration isolation systems by modifying the dynamic response of the actuator using local displacement feedback control, allowing stable vibration isolation to be achieved at lower frequencies without comprising high frequency isolation.

According to one aspect of the invention we provide an inertial actuator assembly comprising an actuator chassis adapted to be secured in use to a structure subject in use to external vibration forces, a proof mass (mₐ) supported with respect to the chassis by a proof mass resilient means, and a force generating transducer means acting between the chassis and the proof mass for subjecting in use the proof mass to a force (fₐ) applied relative to the chassis, a controller arranged to control in use the excitation of the transducer means, characterised by a feedback means H(jω) responsive to a measurement of the displacement (x) of the proof mass relative to the chassis, the controller being arranged to modify the excitation of the force generating transducer means in response to a feedback signal from the feedback means.

Preferably the measurement of displacement is provided by an internal displacement sensor.

Preferably the internal displacement sensor is selected from the group: an electrostatic sensor; an electrical resistance sensor; a capacitive sensor; an inductive sensor; an optical sensor. In a preferred embodiment the internal displacement sensor is a strain gauge.

In order to adjust the natural frequency of the actuator the feedback signal is preferably proportional to the measurement of the displacement.

In order to overcome the problem of static sag associated with low stiffness and provide a self-levelling effect, the feedback signal can be arranged to be proportional to the integral of the measurement of the displacement.

In order to modify the damping of the actuator and control its behaviour at resonances, the feedback signal can be arranged to be proportional to the derivative of the measurement of the displacement.

Preferably, however, the feedback signal should be a combination of a signal proportional to the displacement, a signal proportional to the integral of the displacement and a signal proportional to the derivative of the displacement.

In a preferred embodiment the actuator chassis comprises a casing.

Preferably the force generating transducer means is selected from the group: an electromagnetic motor; a pneumatic motor; an electrostatic motor. In one preferred embodiment the force generating transducer means comprises an electromagnetic motor.

Preferably the inertial actuator comprises a temperature sensor, which, for example, may be configured to prevent overdriving the actuator or to compensate for variations in the response of the system due to temperature fluctuations.

Preferably the inertial actuator also comprises a stop mechanism adapted to restrict the motion of the proof mass relative to the chassis in the event of actuation control failure.

In a preferred embodiment the inertial actuator is employed to improve the stability properties of another, outer, control system by adjusting the dynamic response of the actuator.

Some embodiments of the invention will now be described, by way of example only, with reference to the accompanying drawings. In the following description ‘solid’ denotes a line marked ‘x’ and ‘faint’ denotes a line marked ‘y’:

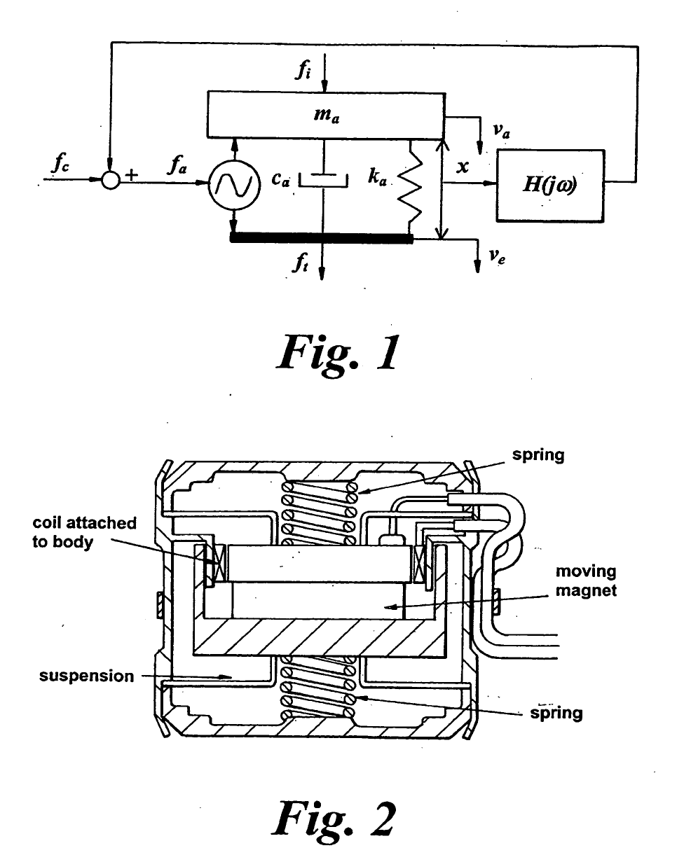

FIG. 1 Schematic of an inertial actuator and implementation of the local displacement feedback control,

FIG. 2 Schematic of the cross-section of an ULTRA Active Tuned Vibration Attenuator, Taken from Hinchliffe et al [6]

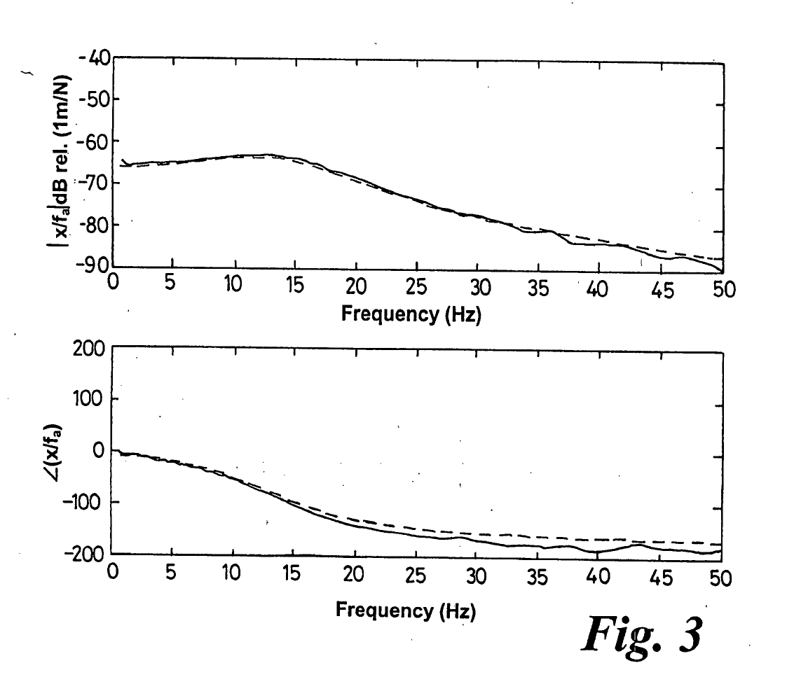

FIG. 3 Frequency response of the relative displacement of the proof-mass per unit actuator force of the ULTRA inertial actuator. The solid line shows the measured data, while the dashed line shows the theoretical prediction,

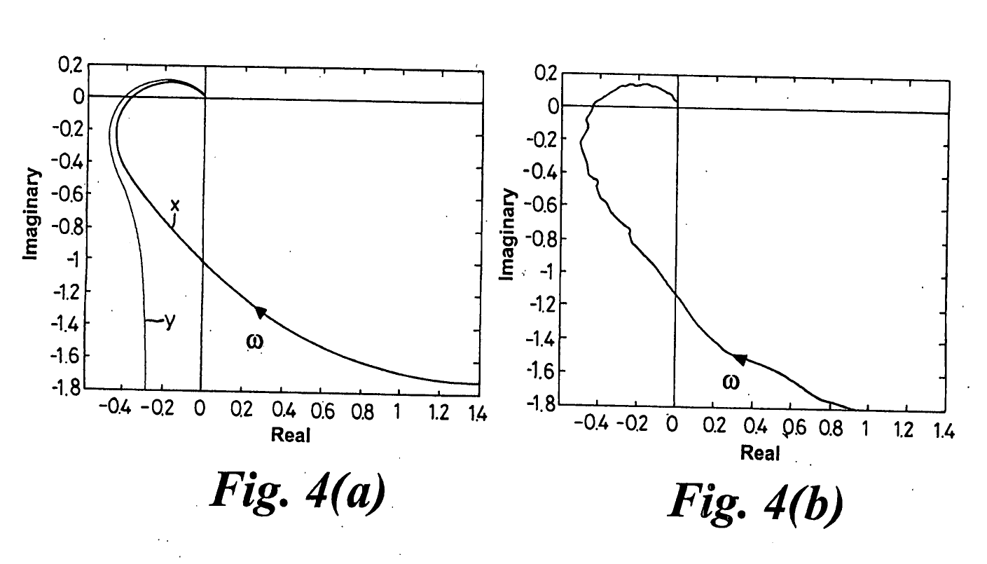

FIG. 4(a) Predicted Nyquist plot of the open loop transfer function, inertial actuator displacement per unit secondary force, when the controller is a realistic (solid) or ideal (faint) self-levelling device based on integral displacement feedback. λ was set to 0.4.

FIG. 4(b) Corresponding measured data,

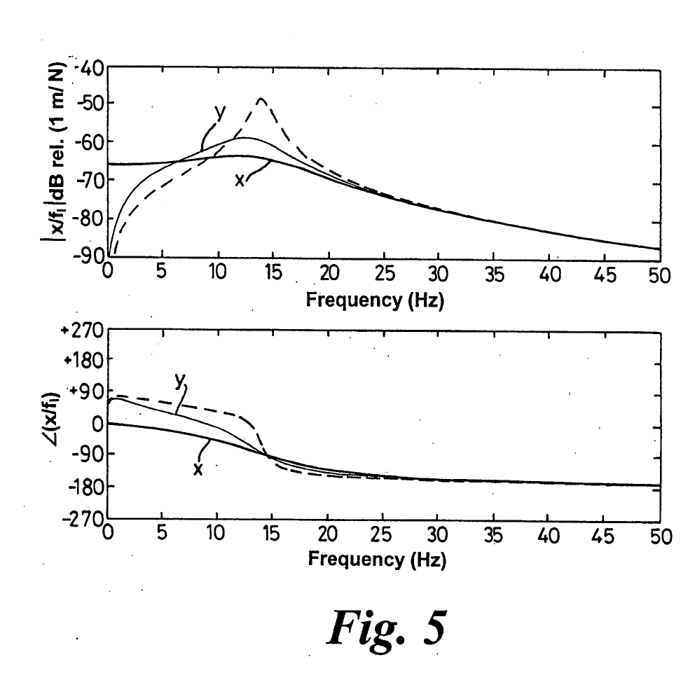

FIG. 5 Predicted inertial response of the system when different ideal local self-levelling feedback loop gains g₁ are used: g₁=0 (solid, corresponding to λ=0, ie no control, g₁=60,000 (faint, λ=0.4), and g₁=105,000 (dashed, λ=0.7),

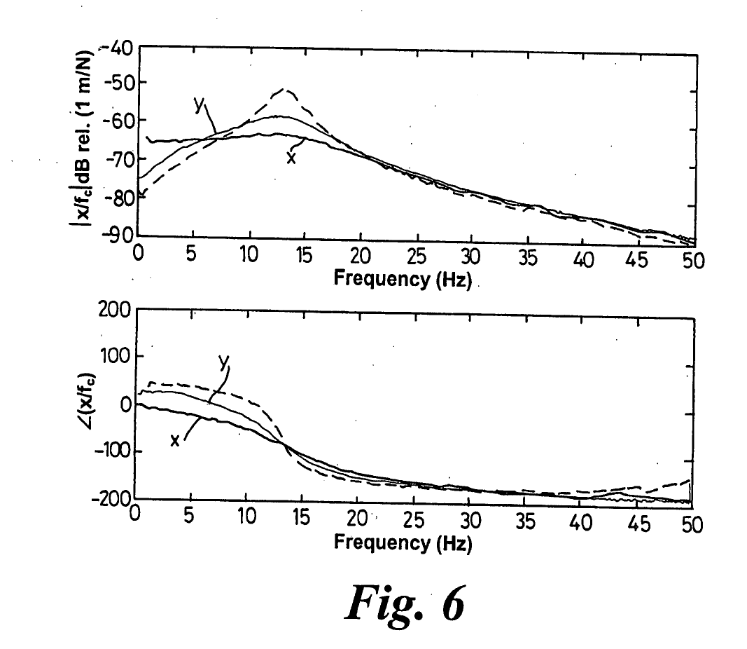

FIG. 6 Measured relative displacement of the proof-mass per unit command force for the passive system (control off, solid) and for two values of the integral feedback gain: λ=0.4 (faint), and λ=0.7 (dashed). The theoretical prediction for this response is the same as that shown in FIG. 5,

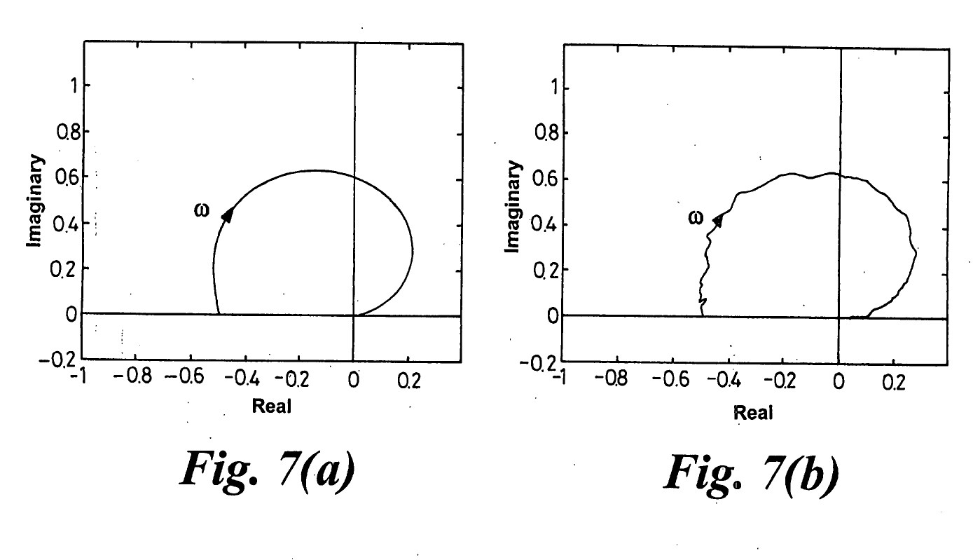

FIG. 7(a) Predicted Nyquist plot of the open loop transfer function, inertial actuator relative displacement per unit secondary force, when the controller is a proportional device based on a negative position feedback gain. For ω=0 the system guarantees a 6 dB stability margin when gₚ=−1000,

FIG. 7(b) Corresponding measured data,

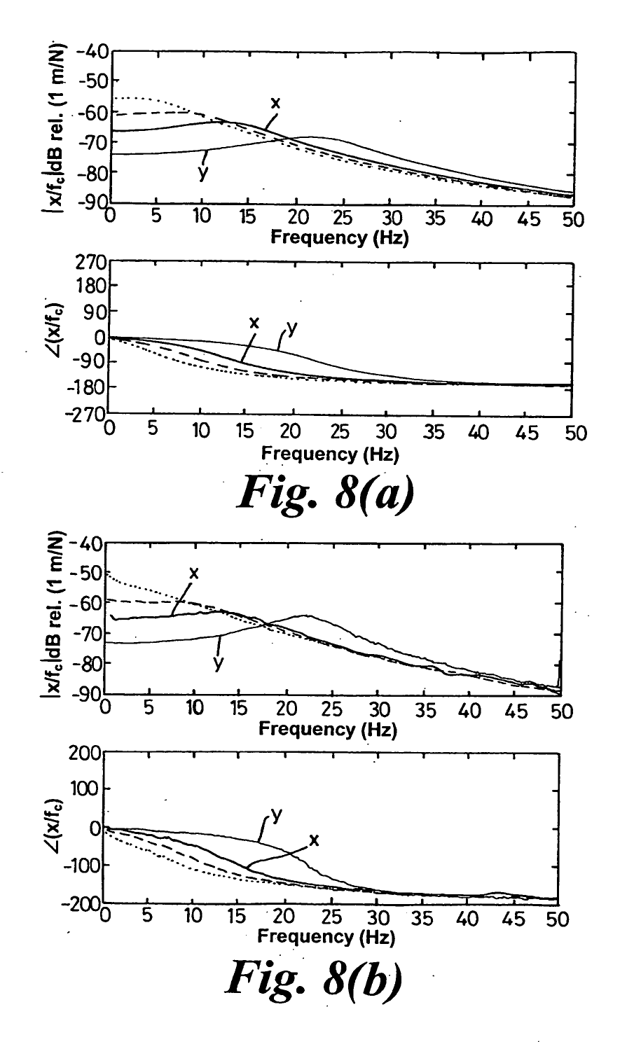

FIG. 8(a) Predicted relative displacement of the inertial actuator's proof-mass per unit command force for the passive system (control off, solid) and for three values of the proportional feedback gain: gₚ=3100 (faint), gₚ=−900 (dashed), and gₚ=−1400 (dotted),

FIG. 8(b) Corresponding measured data,

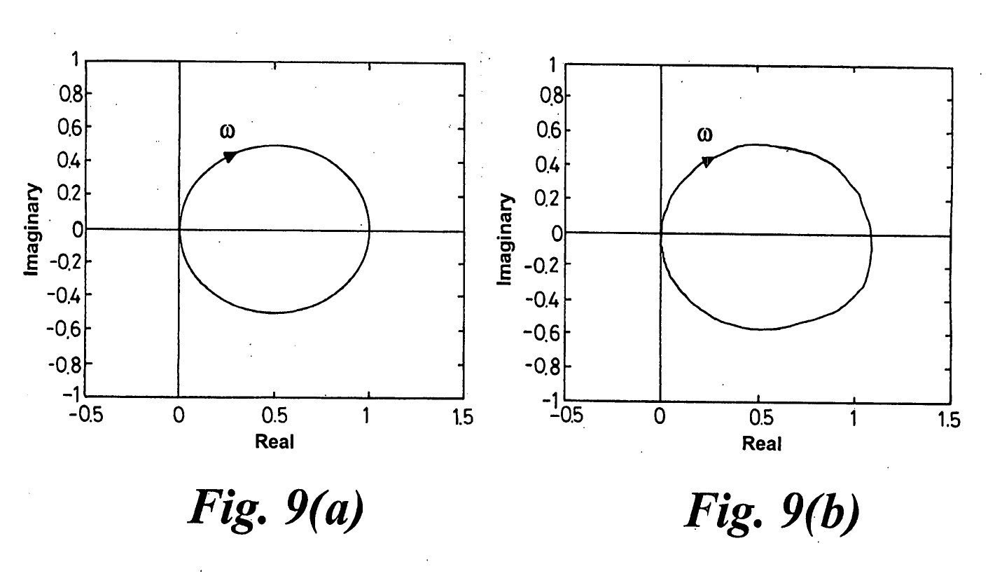

FIG. 9(a) Predicted. Nyquist plot of the open loop transfer function, inertial actuator displacement per unit secondary force, when the controller is the derivative of the relative displacement (gᵥ9=18),

FIG. 9(b) Corresponding measured data,

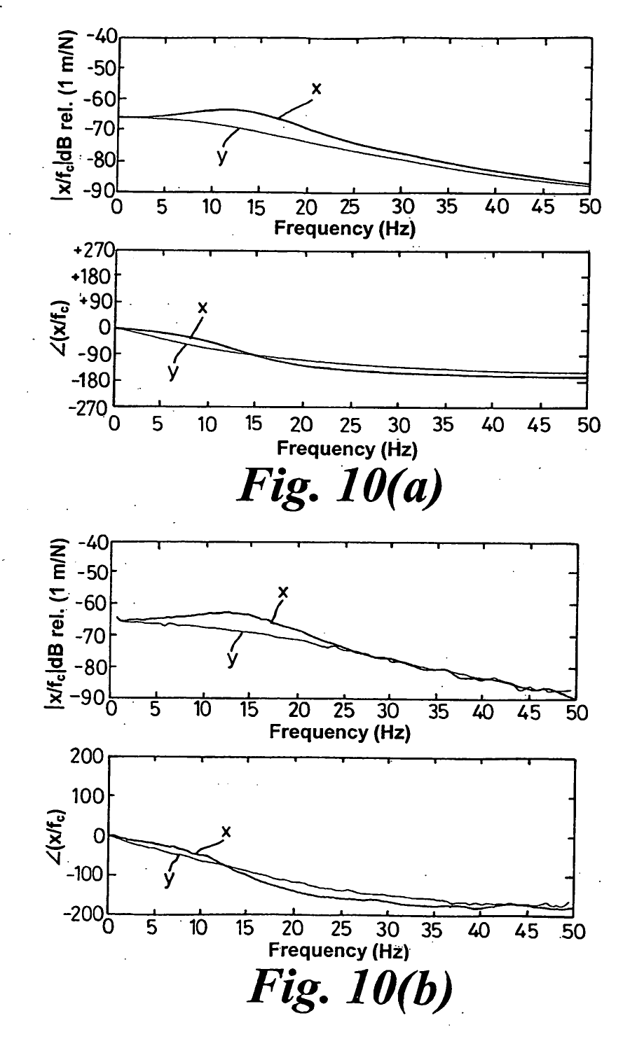

FIG. 10(a) Predicted relative displacement of the proof-mass per unit command force for the passive system (control off, solid) and for one values of the derivative feedback gain: gᵥ=18 (faint),

FIG. 10(b) Corresponding measured data,

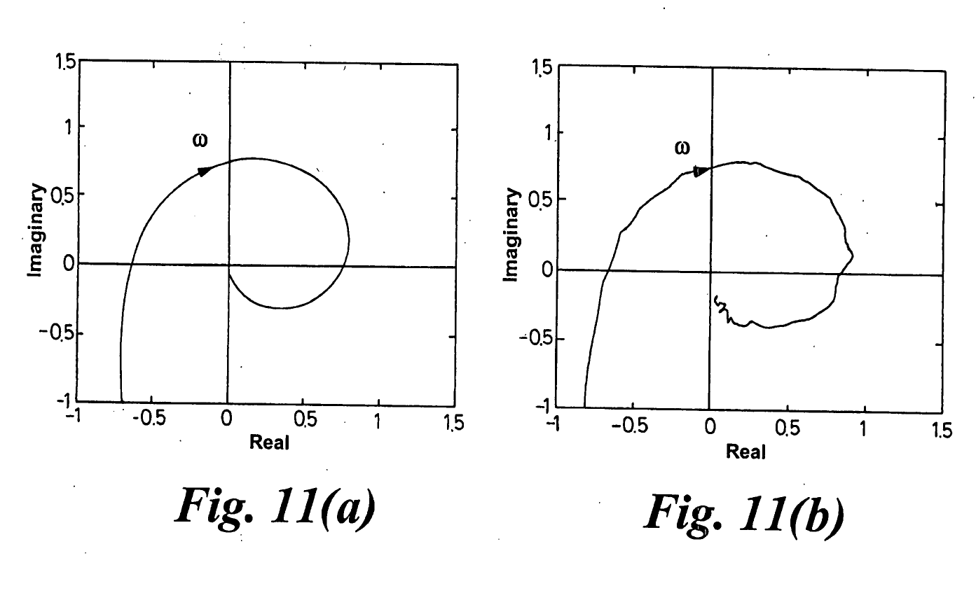

FIG. 11(a) Predicted Nyquist plot of the open loop transfer function, inertial actuator relative displacement per unit secondary force, when the controller is a PID with proportionality gain gₚ=−1000, self-levelling coefficient λ=0.4, and derivative gain gᵥ=18,

FIG. 11(b) Corresponding measured data,

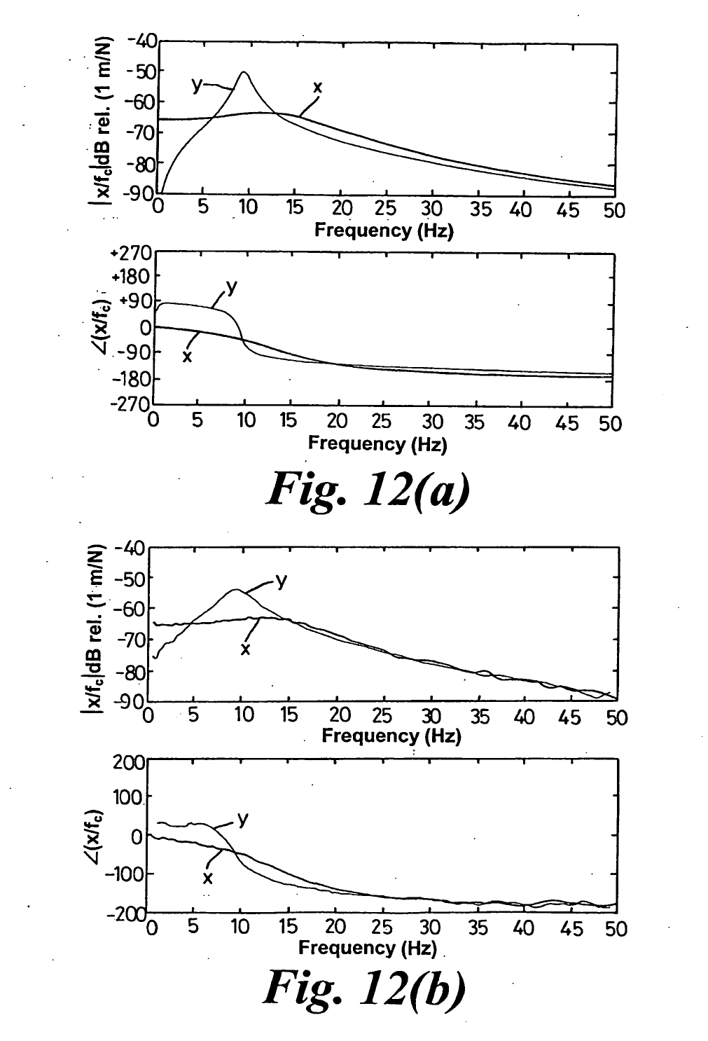

FIG. 12(a) Predicted relative displacement of the proof-mass per unit command force for the passive system (control off, solid) and with the inner PID feedback controller on (faint), with gₚ=−1000, λ=0.4, and gᵥ=18,

FIG. 12(b) Corresponding measured data,

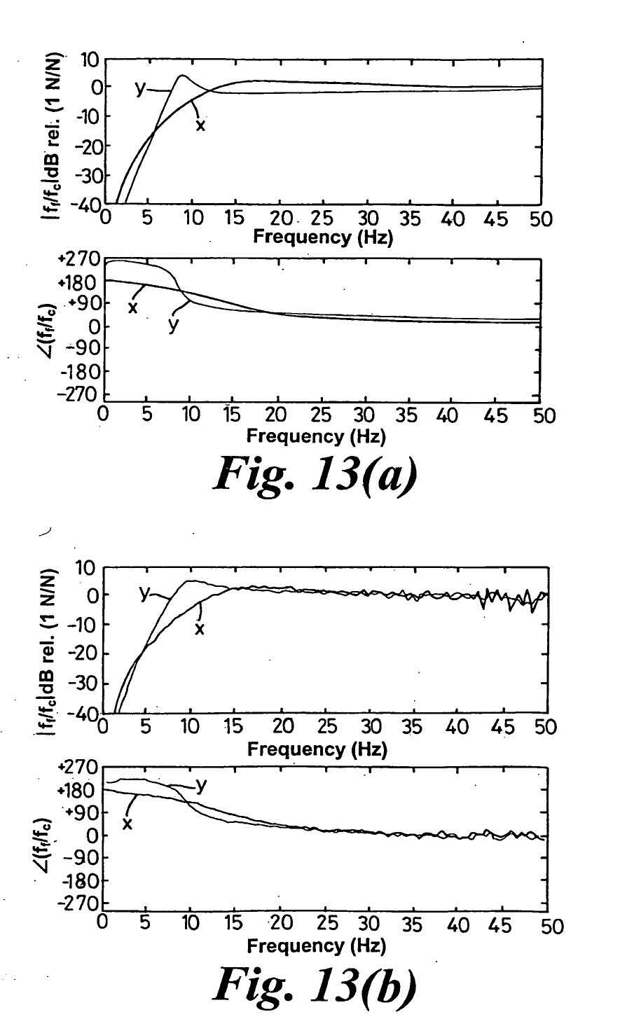

FIG. 13(a) Predicted blocked response of the inertial actuator (solid) and the modified inertial actuator when gₚ=−1000, λ=0.4 and gᵥ=18 (faint),

FIG. 13(b) Corresponding measured data,

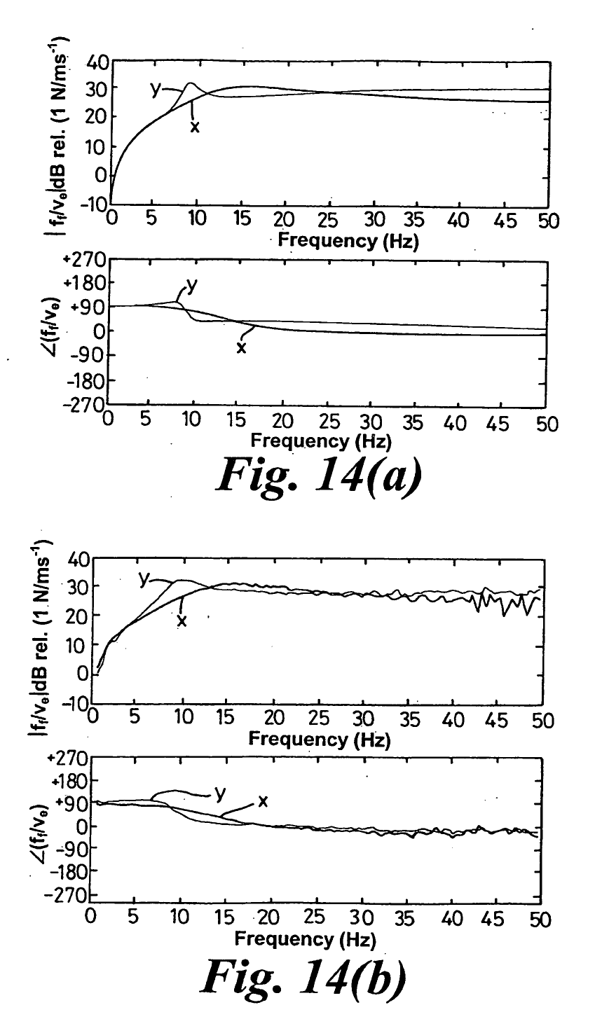

FIG. 14(a) Predicted mechanical impedance of the inertial actuator (solid) and the modified inertial actuator when gₚ=−1000, λ=0.4 and gᵥ=18 (faint),

FIG. 14(b) Corresponding measured data,

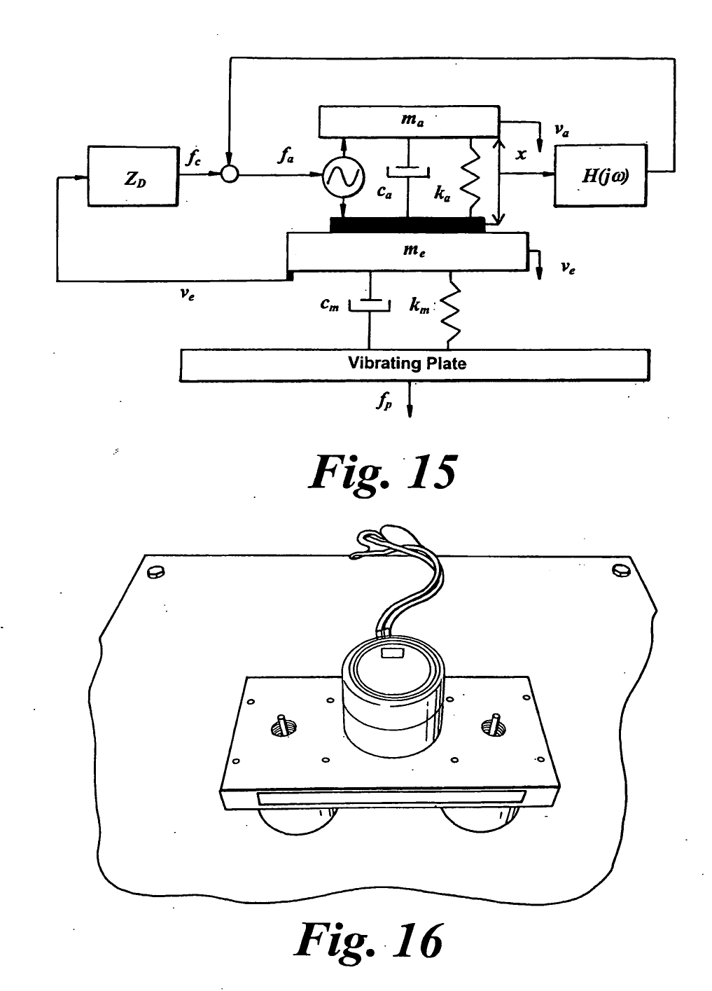

FIG. 15 Schematic of a vibration isolation system with an inertial actuator and implementation of the local control based on displacement feedback and the outer velocity feedback control,

FIG. 16 Image of the core of the experimental set-up, which consists of the piece of equipment, which is mounted on top of passive rubber rings. The ULTRA inertial actuator is directly connected to the equipment,

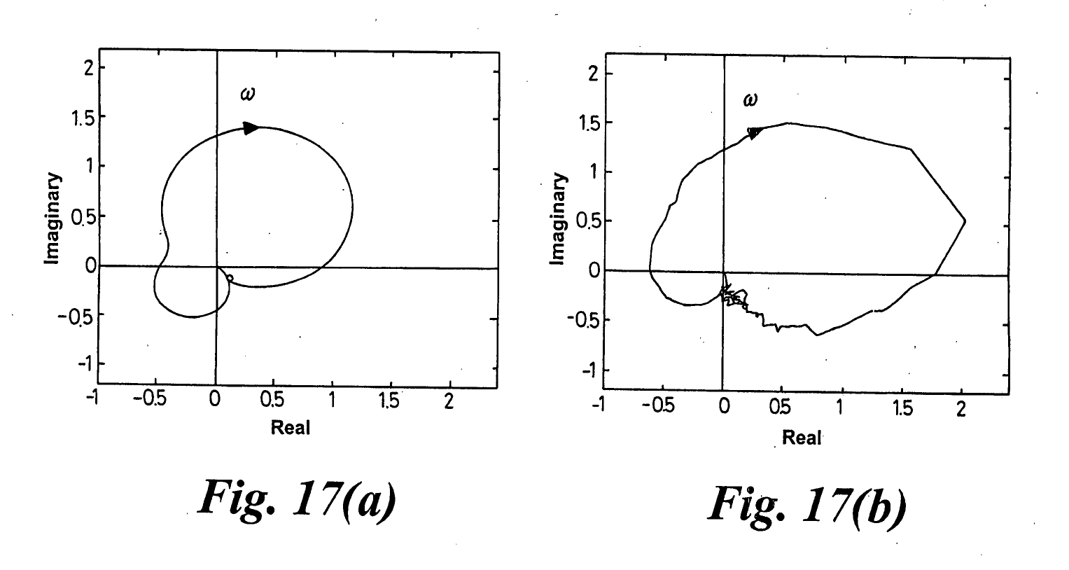

FIG. 17(a) Predicted Nyquist plot of the loop transfer function, equipment velocity per unit command signal, when gₚ=−1000, the self-levelling coefficient λ=0.4, the derivative gain gᵥ=18, and the outer velocity control feedback gain Z_{D′}=60. The modified inertial actuator is directly installed on the equipment,

FIG. 17(b) Corresponding measured data,

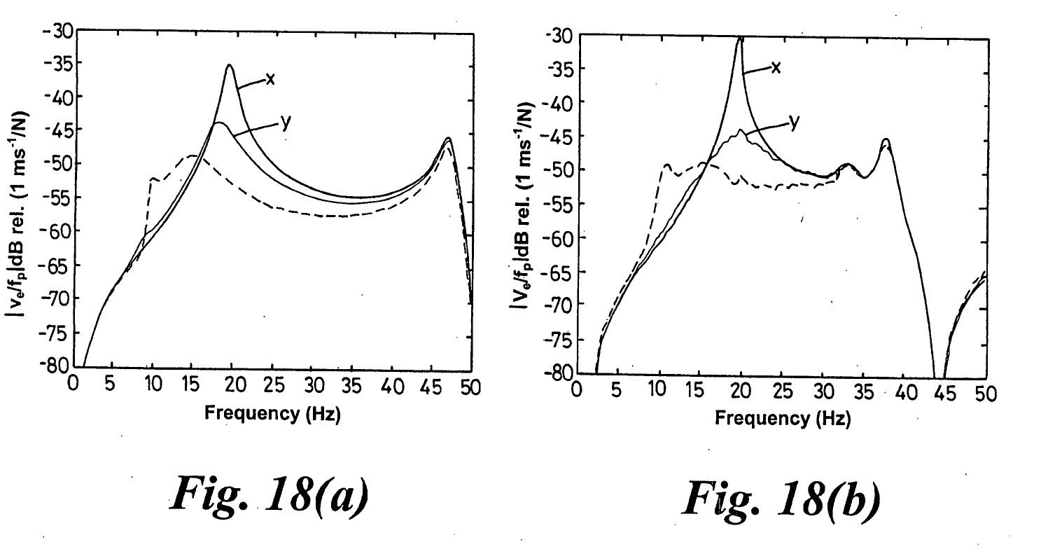

FIG. 18(a) Predicted frequency response of the equipment velocity per primary excitation when no modified inertial actuator is installed (solid), when the modified inertial actuator is installed but no outer velocity feedback loop is implemented (faint), and when both the modified inertial actuator and the outer velocity feedback loop are implemented with Z_{D}=60 (dashed). Under ideal conditions stability is guaranteed when Z_{D}<120.

FIG. 18(b) Corresponding measured data. In this case stability is guaranteed when Z_{D}<90, and

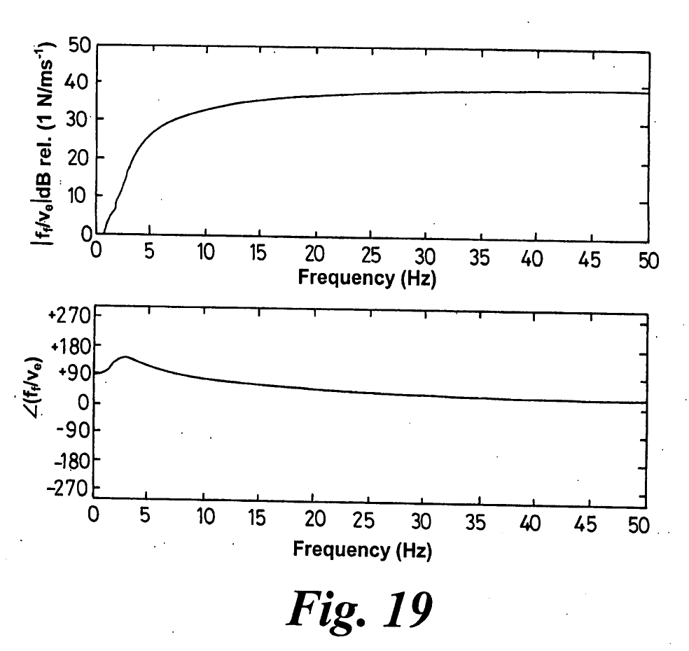

FIG. 19 Mechanical Impedance of the inertial actuator with inner and outer feedback loops when the local displacement feedback control and the outer velocity feedback control are implemented. In particular, gₚ=−1000, λ=0.4, gᵥ=18 and Z_{D}=60.

### INERTIAL ACTUATOR RESPONSE

An inertial actuator has a mass, a “proof-mass”, supported on a spring and driven by an external force. The force in small actuators is normally generated by an electromagnetic circuit. The suspended mass can either be the magnets with supporting structure or in some cases the coil structure. The transduction mechanism which would supply the force to the system is not modelled in detail because its internal dynamics are typically well beyond the bandwidth of the structural response.

A mechanical model of an inertial actuator is shown in FIG. 1, where the effect of H(jω) should be neglected at this stage. A proof-mass, mₐ, is suspended on a spring, kₐ, and a damper, cₐ, and in parallel with them, the actuator forced fₐ drives the mass, which is also affected by the inertial force fᵢ (due to gravity for example). vₐ and vₑ are, respectively, the moving mass velocity and the base velocity. The equation describing the dynamics of the system in FIG. 1 is given by
jωmₐvₐ+cₐ(vₐ−vₑ)+kₐ(vₐ−vₑ)/jω=fᵢ−fₐ, (1)
where vₐ and vₑ are complex velocities and an e^{jωt} time dependence has been assumed. In FIG. 1, x is the relative displacement between the inertial actuator's proof-mass and the inertial actuator's reference base so that jωλ=vₐ−vₑ. Important parameters of the inertial actuator are its resonance frequency, ωₐ, which is given by

$${ω}_{a} = \sqrt{\frac{{k}_{a}}{{m}_{a}}} \qquad ( 2 )$$

and the actuator damping ratio, ζₐ, defined as

$${ζ}_{a} = \frac{1}{2} \frac{{c}_{a}}{\sqrt{{k}_{a} {m}_{a}}} \qquad ( 3 )$$

The inertial actuator used for the experiments described below was a mechanically modified version of an active tuned vibration absorber (ATVA) manufactured by ULTRA Electronics, described in detail in [6] and shown in FIG. 2, from which the internal springs were removed, leaving the proof-mass (mₐ=0.24 Kg) attached to the case by eight thin flexible supports. This modification in the stiffness (so that kₐ=2000 N/m) changed the actuator resonance frequency from 73.8 Hz to 14.5 Hz. The measured damping ratio was used to estimate the damping factor as cₐ=18 N/ms⁻¹. FIG. 3 shows the dynamic response of the relative displacement of the proof-mass, x, per unit actuator force, fₐ, of the ULTRA inertial actuator when mounted on a rigid base. Both measured data and theoretical prediction, calculated from equation (1), are plotted, where the measured data was divided by Bl/R, where Bl is the magnetic force constant of the inertial actuator and R is the inertial actuator electrical impedance, which was found to be resistive within the frequency range of interest. This operation of scaling was necessary in order to guarantee the same units of displacement per unit force for both curves. In an electromechanical actuator the damping is given by the sum of the mechanical and electromagnetic damping and the latter is increased by the fact that a voltage amplifier was used to drive the actuator.

The displacement of the proof-mass was measured using strain gauges on the suspensions. A pair of strain gauges with self-compensating temperature device was installed on opposite sides of one of the internal thin flexible supports which hold the proof-mass inside the actuator. Each strain gauge is a 5 mm rectangular foil type, and consists of a pattern of resistive foil which is mounted on a backing material. The strain gauges used in the actuator are connected to a Wheatstone Bridge circuit with a combination of four active gauges (full bridge). The complete Wheatstone Bridge, which was installed inside the inertial actuator, is excited with a stabilised DC supply and with additional conditioning electronics can be zeroed at the null point of measurement. As stress is applied to the bonded strain gauge, a change of resistance takes place and unbalances the Wheatstone Bridge. This results in a signal output related to the stress value, which is proportional to the proof-mass relative displacement. As the signal value is small (a few millivolts) the signal conditioning electronics provides amplification to increase the signal level to ±1 V, a suitable level for the active vibration isolation application.

In the following sections we will discuss how self-levelling can be implemented by feeding back the integrated displacement, which overcomes the problem of excess actuator displacement due to gravitational forces on the moving mass (i.e. static sag due to low resonance frequency). The damping of the actuator can also be modified by feeding back the derivative of the relative displacement of the inertial actuator. In addition, the inertial actuator's natural frequency can be lowered or increased by feeding back local proportional displacement feedback with either a positive or negative gain.

Inertial Actuator with Self-Levelling Capabilities

The self-levelling system described here uses the inherent actuator force fₐ(t) to level its proof-mass. The sensing element which measures the position of the actuator proof-mass relative to the inertial actuator reference plane was a strain gauge, although an optical sensor was also investigated for this purpose. The sensing element is attached so that when the sensor is in its neutral position, the moving mass is at its desired operating height. The electrical signal is integrated and amplified by the controller, providing the control effort to operate the actuation device within the inertial actuator. The system then produces a force that is proportional to the integral of the signal from the sensor.

When a force of constant magnitude is applied to the proof-mass, causing a relative deflection of the mass on its spring element, the sensor supplies an electrical signal proportional to the mass relative displacement to the integral controller. In response, the controller generates an electrical signal that continues to increase in magnitude as long as the relative displacement is not zero. The signal from the controller is applied to the inertial actuator, which generates a force in a direction that decreases the mass deflection. The force follows the controller signal and continues to increase in magnitude as long as the relative deflection is not zero. At some point in time the force will exactly equal the constant force applied on the moving mass, requiring a relative displacement of zero. The output from the sensor is zero, therefore the output from the controller no longer increases but is maintained at a constant magnitude required for the actuator to generate a force exactly equal to the constant force applied to the proof-mass. The isolation system remains in this equilibrium condition until the force applied to the proof-mass changes and causes a nonzero signal to be generated by the sensing element, and the process starts all over again.

The inertial actuator with local displacement feedback control is shown schematically in FIG. 1. The relative displacement x is measured and fed back to the inertial actuator through a feedback controller with frequency response H(jω), which in the first instance is equal to g₁/jω. The control command f_{c} can be considered, in control terms, as the reference point [7]. If we assume that the control force is given by the sum of a control command f_{c} and the time integral of the measured relative displacement between the inertial actuator proof-mass and its reference base, multiplied by a gain g₁
fₐ=f_{c}+g₁∫x(t)dt (4)
then a self-levelling device is implemented.

In order to examine the stability of the closed-loop system, composed of the inertial actuator and the self-levelling controller, the open loop gain was computed. It is given by the product of the plant response, G(jω), (measured relative displacement per unit control force, x/fₐ, obtained from equation (1) by imposing fᵢ=0 and vₑ=0, since it is assumed to be mounted on a rigid base) multiplied by the control law

$$H ( jω ) = \frac{{g}_{I}}{jω}$$

$$G ( jω ) H ( jω ) = \frac{1}{( - {ω}^{2} {m}_{a} + jω {c}_{a} + {k}_{a} )} ( \frac{{g}_{I}}{jω} ) . \qquad ( 5 )$$

The faint line in FIG. 4(a) shows the calculated Nyquist plot, when g₁ is equal to 60,000 in equation (5), and the corresponding experimental Nyquist plot is shown in FIG. 4(b). It can be noted that the system is conditionally stable and the Routh-Hurwitz criterion can be used to show that the system is only stable if λ<1[8], where

$$λ = \frac{{g}_{I}}{2 {ζ}_{a} {ω}_{a} {k}_{a}} . \qquad ( 6 )$$

When g₁ is equal to 60,000, the corresponding λ is equal to 0.4, which also coincides with the negative real part of G(jω)H(jω) when the imaginary part is zero in FIG. 4. The low frequency measurements in FIG. 4(b) cannot be considered very reliable because of noise limitations, even though the general behaviour of the open loop system is clear, including the behaviour due to the real integrator. In a real system, the integrator's control law is not described by equation (5), but more realistically by an equation that includes a cut off frequency (at 1.5 Hz in this case), a finite DC magnitude, and a phase shift at DC of 0°, rather than 90°, as in the ideal case described by equation (5). A realistic expression for such control law is given by

$${H}_{1} ( jω ) = \frac{{g}_{I}}{1 + jω0 .106} . \qquad ( 7 )$$

Consequently, the ideal open-loop system response described by equation (5) is then replaced by a more realistic equation given by

$$G ( jω ) {H}_{1} ( jω ) = \frac{1}{( - {ω}^{2} {m}_{a} + jω {c}_{a} + {k}_{a} )} \frac{{g}_{I}}{( 1 + jω0 .106 )} , \qquad ( 8 )$$

which shows that at DC the Nyquist plot starts at

$$\frac{{g}_{I}}{{k}_{a }}$$

on the positive real axis, and then behaves as shown by the solid line in FIG. 4(a).

The response of the actuator to an inertial force, fᵢ, can be computed by setting the control command to zero. The relative displacement x per unit inertial force fᵢ, when an ideal self-levelling device is implemented, is then given by

$$\frac{x}{{f}_{i}} = \frac{1}{- {ω}^{2} {m}_{a} + jω {c}_{a} + {k}_{a} + {H}_{1} ( jω )} , \qquad ( 9 )$$

whose behaviour is plotted in FIG. 5 for different values of the local displacement feedback gain g₁. Without integral displacement feedback (solid line), the response of the system to a static force is equal to 1/kₐ, while with ideal integral displacement feedback it tends to zero, which shows that the servo action of the feedback controller will compensate for any static load. In realistic implementations, as described by equation (9), the static deflection is equal to 1/(kₐ+g₁). The low frequency behaviour is important because it determines how well the system performs in cases like an aircraft manoeuvre or a vehicle turn. In other words, besides counter-balancing the sagging effect due to gravity, the system must be able to centre the proof-mass and prevent it from banging against the stop-ends during manoeuvres. For example, without control the relative displacement of the proof-mass, due to the gravitational force fᵢ=mₐg, where g=9.8 ms⁻² is the gravitational acceleration, on the spring kₐ is given by

$$x = \frac{{f}_{i}}{{k}_{a}} = 1.2 mm ,$$

while with the self-levelling control the relative displacement is equal to

$$x = \frac{{f}_{i}}{{k}_{a} + {g}_{I}} = 38 µm .$$

In case of a 10 g manoeuvre the relative displacement without control would be an unsatisfactory 11.8 mm, while with control this distance would be reduced to 0.38 mm. However, at the inertial actuator resonance frequency, enhancement of the response is experienced and this enhancement increases with the gain g₁, until the system becomes unstable. When the actuator stiffness, kₐ, decreases, the critical value of the gain g₁ decreases as well and therefore in order to have the same stability margin, lower gains are needed.

FIG. 6 shows the experimental proof-mass relative displacement x per unit control command f_{c}, which is given by

$$\frac{x}{{f}_{c}} = \frac{1}{- {ω}^{2} {m}_{a} + jω {c}_{a} + {k}_{a} + {H}_{1} ( jω )} , \qquad ( 10 )$$

which has the same form as equation (9) whose theoretical relative displacement per unit force is shown in FIG. 5. In both theory and experiment the increase in magnitude at the resonance can be noted, which is a sign of getting closer to instability, along with an additional phase shift at low frequency.
Inertial Actuator with PID Control

In the previous section we saw that with a displacement sensor integral control gave a self-levelling action. In this section we discuss the physical effect of proportional and derivative control in a more general PID controller.

If the inertial actuator resonance frequency is too high for the specific application, it can be lowered using a negative direct position feedback control loop, H₂(jω)=g_{P}, where g_{P} is negative. In order to determine whether the closed-loop system in FIG. 1 is stable with such a controller, the open loop gain was computed. It is given by the product of the plant response, G(jω), defined above, multiplied by H₂(jω)

$$G ( jω ) {H}_{2} ( jω ) = \frac{1}{- {ω}^{2} {m}_{a} + jω {c}_{a} + {k}_{a}} ( {g}_{P} ) . \qquad ( 11 )$$

The maximum feedback gain g_{P} before instability is equal to the value of the stiffness term kₐ. FIG. 7 shows the corresponding theoretical and experimental Nyquist plot for a value of the gain g_{P} that is equal to −kₐ/2, which guarantees a 6 dB stability margin. Lowering the resonance frequency also implies that smaller values of the gain g₁ are needed for self-levelling purposes. FIG. 8 shows the theoretical and measured proof-mass displacement x per unit control command f_{c} described in equation (10) when the local feedback controller, H₂(jω), comprises the proportional term, g_{P}, only. If the position feedback gain was positive, the natural frequency would be increased with no danger of instability. When negative position feedback gains are implemented, the actuator resonance frequency can be lowered, but stability issues emerge as the total system stiffness tends to zero.

The stability analysis of the closed-loop system when an ideal derivation controller, H₃ (jω)=jωg_{V}, is used within the local loop, is obtained by studying the open loop transfer function

$$G ( jω ) {H}_{3} ( jω ) = \frac{1}{- {ω}^{2} {m}_{a} + jω {c}_{a} + {k}_{a}} ( jω {g}_{V} ) \qquad ( 12 )$$

which is composed of the product of the plant response, G(jω), times the controller. In a real implementation, the frequency response of the derivative term has got a cut-off frequency after which the input signal is multiplied by a constant gain [9]. As long as this cut-off frequency lies above the maximum frequency of interest, then H₃(jω) can be considered as a good approximation to this part of the feedback controller when modelling realistic systems. FIG. 9 shows the predicted Nyquist plot of the open loop system, described by equation (12), and the corresponding measured data. Theory and experiment agree well, and they both lie in the positive real half plane, indicating that by increasing the controller gain gᵥ, damping is added to the dynamics of the inertial actuator. At frequencies higher than the plotted range of interest, the experimental curve enters the third quadrant. This mainly happens because the derivative block is in reality a high pass filter [9], so its magnitude becomes constant after a certain frequency and its phase tend to zero. This indicates that in a real implementation the stability margin of the closed-loop system is reduced and the amount of damping that can be added to the system is large, but finite. An additional limitation is that the noise that is present in the measured signal is amplified by the derivative controller. FIG. 10 shows the frequency response of the uncontrolled inertial actuator and the controlled system when a local derivative feedback loop is implemented. A value of the feedback gain g_{V} was chosen so that is equal to the uncontrolled cₐ so that the overall value is doubled. The uncontrolled case is already damped appropriately, but since the self-levelling integral feedback loop tends to increase the magnitude of the resonance, an additional damping term will be required when the whole PID controller is implemented, as discussed below. The experimental measurements and theoretical predictions again agree well, indicating that using a local derivative feedback controller it is possible to add damping and therefore change the dynamic behaviour of an inertial actuator.

If the integral displacement term, the proportional term and the derivative of the displacement are added in parallel within the local feedback controller, the control law in FIG. 1 becomes of the form
H(jω)=H₁(jω)+H₂(jω)+H₃(jω) (13)
which describes a typical ideal PID controller. In order to determine whether the closed-loop system in FIG. 1 is stable with such a controller, the open loop gain was computed. It is given by the product of the plant response, G(jω), multiplied by H(jω)

$$G ( jω ) H ( jω ) = \frac{1}{- {ω}^{2} {m}_{a} + jω {c}_{a} + {k}_{a}} ( {g}_{P} + \frac{{g}_{I}}{1 + jω0 .106} + jω {g}_{V} ) \qquad ( 14 )$$

FIG. 11 shows the corresponding theoretical and experimental Nyquist plot for a value of the gain g_{P} that is equal to −kₐ/2, a value of g₁ which guarantees λ=0.4, and a value of g_{V}=18. The closed loop system is conditionally stable, and the stability depends on the combined choice of the proportional gain and the self-levelling gain. The curve starts off at

$$\frac{{g}_{P} + {g}_{I}}{{k}_{a}}$$

and then intersects the real axis in its negative portion before reaching the origin. FIG. 12 shows the theoretical and measured proof-mass relative displacement x per unit control command f_{c} for the uncontrolled inertial actuator and for the modified inertial actuator, when the local feedback controller, H(jω), has the same value of the gains as above. In this case the inertial actuator natural frequency was lowered to about 10 Hz and this configuration was used in the active vibration isolation problem discussed in the next section.

In summary, if it is necessary to reduce the resonance frequency of the actuator because it is greater or equal to the first structural mode of the system that needs to be isolated, this can be done with a negative position feedback gain. If this action induces unwanted deflections because of the low stiffness of the closed-loop system, then a self-levelling mechanism can be employed, which is based on a integral displacement feedback. By doing so, however, the overall system gets closer to instability and additional damping is needed. Another reason why damping may be necessary is if an outer velocity feedback is to be implemented. It was shown by Elliott et al. [4] that this kind of system is conditionally stable and the vicinity to the Nyquist point depends on how well damped the inertial actuator is. For these reasons the implementation of a local rate feedback control turns out to be very effective in increasing the damping of the actuator.

From FIG. 1, the equation that describes the complete modified inertial actuator once the local PID feedback control, described by equation (13), is implemented, can be calculated. It is given by

$${f}_{t} = \frac{- {ω}^{2} {m}_{a}}{- {ω}^{2} {m}_{a} + jω {c}_{a} + {k}_{a} + H ( jω )} {f}_{c} - \frac{( jω {m}_{a} {k}_{a} - {ω}^{2} {m}_{a} {c}_{a} ) \cdot ( H ( jω ) + jω {Z}_{a} )}{( - {ω}^{2} {m}_{a} + jω {c}_{a} + {k}_{a} + H ( jω ) ) jω {Z}_{a}} {v}_{e} \qquad ( 15 )$$

where

$${Z}_{a} = {c}_{a} + \frac{{k}_{a}}{jω}$$

is the mechanical impedance of the actuator suspension. Equation (15) can be grouped as
fₜ=Tₐ′f_{c}−Zₐ′vₑ (16)
where Tₐ′ and Zₐ′ are the blocked response and mechanical impedance of the actuator, as modified by the local displacement feedback. FIG. 13 shows the predicted and measured blocked response of the uncontrolled inertial actuator and the modified inertial actuator. At frequencies higher than the actuator resonance, the transmitted force fₜ tends to the control command f_{c}. This means that the blocked response shows that the transmitted force fₜ can be regulated using the control command f_{c}. FIG. 14 shows the calculated and measured mechanical impedance of the actuator before and after control. When gᵥ increases, the mechanical impedance increases at high frequencies. The magnitude plot in FIG. 14 shows that, starting from the solid line which tends, at high frequency, to cₐ=18 N/ms⁻¹, the damping of the device increases cₐ+gᵥ=36 N/ms⁻¹. The phase plot in FIG. 14 shows that above resonance, the mechanical impedance is damping dominated and the system shows a skyhook damping behaviour.
Active Isolation with the Modified Inertial Actuator

In this section we consider the use of an inertial actuator with local feedback for the active isolation of a rigid equipment structure supported on a flexible base by a resilient mount. The arrangement is illustrated schematically in FIG. 15, and is described fully by Benassi et al. [10,11]. It consists of a flexible steel base plate 700 mm×500 mm×2 mm thick, clamped on the two longer sides, which supports a rigid equipment structure modelled as a point mass (mₑ=1.08 Kg) on which is mounted an inertial actuator. The equipment structure is supported by a mount, which has a stiffness, kₘ=20000 N/m, and damping, cₘ=18 N/ms⁻¹. The model assumes that the system is divided into four elements: a vibrating plate acting as the base structure, a passive mount, the equipment, and the inertial actuator. The uncontrolled actuator has a resonance frequency of 14.5 Hz and has a damping ratio of about ζₐ=0.4, the mounted equipment has a resonance frequency of about 21.5 Hz and a damping ratio of about ζ=5.2%, and the vibrating base has a first resonance frequency of about 44.8 Hz and a damping ratio of about ζ=4.8%. An inner displacement feedback loop is used to modify the response of the inertial actuator, as discussed above, and an outer velocity feedback system is used to provide active skyhook damping for the equipment, also illustrated in FIG. 15.

The expression for the equipment velocity as a function of the primary force fₚ and the transmitted force fₜ, is given by [11]

$${v}_{e} = \frac{{Y}_{e} {Z}_{m} {Y}_{b}}{1 + {Z}_{m} ( {Y}_{e} + {Y}_{b} )} {f}_{p} + \frac{{Y}_{e} ( 1 + {Y}_{b} {Z}_{m} )}{1 + {Z}_{m} ( {Y}_{e} + {Y}_{b} )} {f}_{t} \qquad ( 17 )$$

where Yₑ is the mobility of the equipment structure, Y_{b} is the mobility of the base structure and Zₘ is the mechanical impedance of the mount. Since the equipment structure is assumed to behave entirely like a rigid body of mass mₑ, its input mobility is equal to Yₑ=1/(jωmₑ). The mount is assumed to have a negligible mass, and so without loss of generality its impedance can be written as

$${Z}_{m} = \frac{{k}_{m}}{jω} + {c}_{m} \qquad ( 18 )$$

where kₘ is the mount's stiffness and cₘ its damping factor, both of which may be frequency dependent. Substituting equation (16) into (17), the expression for the equipment velocity, when the modified inertial actuator is attached on the equipment, is given by

$${v}_{e} = \frac{{Y}_{e} {Z}_{m} {Y}_{b}}{1 + {Z}_{m} ( {Y}_{e} + {Y}_{b} + {Y}_{e} {Z}_{a}^{′} {Y}_{b} ) + {Y}_{e} {Z}_{a}^{′}} {f}_{p} + \frac{{Y}_{e} {T}_{a}^{′} ( 1 + {Y}_{b} {Z}_{m} )}{1 + {Z}_{m} ( {Y}_{e} + {Y}_{b} + {Y}_{e} {Z}_{a}^{′} {Y}_{b} ) + {Y}_{e} {Z}_{a}^{′}} {f}_{c} \qquad ( 19 )$$

If the control law of the outer feedback loop is assumed to take the form f_{c}=−Z_{D}vₑ, where Z_{D} can be interpreted as the desired impedance of the outer feedback system, then equation (19) can be used to derive the equipment velocity per primary force with both feedback loops as given by

$${v}_{e} = \frac{{Y}_{e} {Z}_{m} {Y}_{b}}{1 + {Z}_{m} ( {Y}_{e} + {Y}_{b} + {Y}_{e} {Z}_{a}^{′} {Y}_{b} ) + {Y}_{e} {Z}_{a}^{′} + {Y}_{e} {T}_{a}^{′} ( 1 + {Y}_{b} {Z}_{m} ) {Z}_{D}} {f}_{p} \qquad ( 20 )$$

FIG. 16 shows the active isolation system used in the experimental work. It consists of an aluminium mass acting as the equipment structure, two mounts placed symmetrically underneath the aluminium mass and a modified ULTRA inertial actuator to produce the control force. The values of the gains within the PID controller were chosen in order to provide the modified inertial actuator described in FIG. 12(b).

The aluminium mass had been previously shown [12] to behave as a rigid body up to 1000 Hz, which is well above the maximum frequency of interest in this experimental study. This system is attached to a flexible plate made of steel. Further details on the passive mount system are given by Gardonio et al. [13], and a detailed analysis of the experimental set-up is given by Benassi et al. [14].

The stability of the closed loop system can be assessed from FIG. 17(a), which shows the predicted Nyquist plot of the open loop response of the plant, based on the modified inertial actuator on the passive isolation system and described by the second term of equation (19), and the outer velocity feedback control gain Z_{D}. In this configuration, a gain of Z_{D}=60 guarantees a 6 dB stability margin. The corresponding measured data is shown in FIG. 17(b), which shows that the same stability margin is guaranteed when Z_{D}=45. FIG. 18(a) shows the equipment velocity per unit primary excitation for the uncontrolled case and for different gains in the outer feedback loop. There is a difference between the equipment-dominated resonance frequency when no device is installed (solid line), and the new resonance frequency of the system when the modified inertial actuator is applied on top of the piece of equipment (faint line). This is due to the actuator acting as a tuned vibration neutraliser, as explained by den Hartog [15]. This “passive” effect of the modified inertial actuator with local feedback on the equipment dynamics can be seen from the response when the outer loop is not implemented (Z_{D}=0), which shows a lowered and well damped first resonance frequency, dominated by the actuator's response, as well as a damped equipment resonance frequency. In this case, the damping effect seems to be more evident than the mass-loading effect. When the local feedback gain gᵥ is increased, substantial damping is added to the system and both the first and second resonances are well attenuated, while attenuation at higher frequencies is experienced for high values of the gain gᵥ.

Good vibration isolation conditions can be achieved at the mounted natural frequency of the equipment by the modified inertial actuator and the outer velocity feedback loop. The outer loop, with response Z_{D}, improves the behaviour of the equipment-dominated resonance, but it also enhances the magnitude of the inertial actuator resonance, as expected, by up to 10 dB at 10 Hz in FIG. 18. When Z_{D}=60 (dashed line in FIG. 18(a)), an impressive 24 dB attenuation is present at the equipment resonance frequency compared to the case where no device is installed.

In a real implementation the situation becomes a little more critical, as depicted in FIG. 18(b). The dashed line in particular shows a higher peak at the actuator resonance, which is a sign of being closer to the unstable region. The dashed line, obtained for Z_{D}=60, has a very good stability margin and a 22 dB attenuation at the equipment resonance frequency, which implies that Z_{D}=60 is a perfectly reasonable ambition in a real implementation. The system with both inner PID and outer velocity feedback loops thus has a good stability margin and it performs very well.

The mechanical impedance of the modified actuator with outer velocity feedback loop is given from equation (15) by substituting f_{c}=−Z_{D}vₑ

$$Z = \frac{( jω {m}_{a} {k}_{a} - {ω}^{2} {m}_{a} {c}_{a} ) \cdot [ H ( jω ) + jω {Z}_{a} ] - {jω}^{3} {m}_{a} {Z}_{a} {Z}_{D}}{( {k}_{a} + jω {c}_{a} - {ω}^{2} {m}_{a} + H ( jω ) ) jω {Z}_{a}} \qquad ( 21 )$$

which is plotted in FIG. 19 for the same values of the PID gains used in the experiments and an outer velocity gain of Z_{D}=60. It can be noted that the actuator impedance Z=fₜ/vₑ, past the first resonance frequency, tends to the desired impedance plus the derivative gain and the mechanical damping factor, Z_{D}+g_{V}+cₐ=96 N/ms⁻¹, which indicates that the overall system, composed of the modified inertial actuator with outer feedback loop, is similar to a skyhook damper.

### SUMMARY

In using an inertial actuator for active vibration isolation, resonance frequency should be lower than the first natural frequency of the system under control and it should be well damped. Actuators with very low resonance frequencies, however, have large static displacements due to gravity. To solve this problem, a new device has been disclosed. It is an inertial actuator and has a local PID feedback loop which uses the measurement of the relative displacement between the actuator chassis and the actuator moving mass. The control law is the sum of an integral term, which provides self-levelling and solves the sagging problem, a derivative term, which provides the device with sufficient initial damping to guarantee a very good stability margin, and a positive or negative proportional term, which determines the actuator resonance frequency.

It was found from the simulations and the experiments that the new device is effective in actively isolating a piece of equipment from the vibrations of a base structure. Although the overall system is conditionally stable, very good performance can be achieved. Using negative proportional feedback loop gains, it is possible to lower the resonance frequency of the inertial actuator. Finally, damping can be added through the derivative component of the PID controller. In summary, it is possible to change the dynamic response of an inertial actuator using a local PID feedback controller and when this system is applied as a vibration isolator, the results have been shown to be very good.

### REFERENCES

1. C. E. CREDE 1995, Shock and Vibration Handbook, C. M. Harris, ed., McGraw Hill, New York. Theory of Vibration Isolation, Chapter 30.
2. E. E. UNGAR 1992, Noise and Vibration Control Engineering, L. Beranek and I. L. Ver, eds., Wiley, Chichester. Vibration Isolation, Chapter 11.
3. D. KARNOPP 1995, ASME J. Mech. Des., 117, 177-185. Active and Semi-active Vibration Isolation.
4. S. J. ELLIOTT, M. SERRAND and P. GARDONIO 2001, ASME Journal of Vibration and Acoustics, 123, 250-261. Feedback stability limits for active isolation systems with reactive and inertial actuators.
5. R. W. HORNING and D. W. SCHUBER 1988, Shock and Vibration Handbook, C. M. Harris, ed., McGraw Hill, New York. Theory of Vibration Isolation, Chapter 33.
6. R. HINCHLIFFE, I. SCOTT, M. PURVER, and I. STOTHERS 2002 Proc. ACTIVE2002 Conference, Southampton, U.K., 15-17 Jul. 2002. Tonal Active Control in Production on a Large Turbo-Prop Aircraft.
7. G. F. FRANKLIN 1994, Feedback Control of Dynamic Systems, Addison-Wesley, 3^{rd} Ed.
8. S. J. ELLIOTT 2000 ISVR Contract Report No. 00/28. Active Isolation Systems: A State-of-the-Art Study.
9. M. J. BRENNAN, K. A. ANANTHAGANESHAN and S. J. ELLIOTT 2002 Proc. ACTIVE2002 and submitted to ASME Journal of Vibration and Acoustics. Low and high frequency instabilities in feedback control of vibrating single-degree-of-freedom systems.
10. L. BENASSI, P. GARDONIO and S. J. ELLIOTT 2002 Proc. ACTIVE2002 Conference, Southampton, U.K., 15-17 Jul. 2002. Equipment Isolation of a SDOF System with an Inertial Actuator using Feedback Control Strategies.
11. L. BENASSI, S. J. ELLIOTT and P. GARDONIO 2003 Journal of Sound and Vibration. Active Vibration Isolation using an Inertial Actuator with Local Force Feedback Control. Accepted for publication.
12. M. SERRAND 2000 MPhil Thesis, University of Southampton. Direct velocity feedback control of equipment velocity.
13. P. GARDONIO, S. J. ELLIOTT and R. J. PINNINGTON 1996 ISVR Technical Memorandum No. 801. User Manual for the ISVR Isolation System with Two Active Mounts for the ASPEN Final Project Experiment.
14. L. BENASSI, S. J. ELLIOTT and P. GARDONIO 2002 ISVR Technical Memorandum No. 896. Equipment Isolation of a SDOF System with an Inertial Actuator using Feedback Control Strategies—Part II: Experiment.
DEN HARTOG 1985, Mechanical Vibrations, Dover Publications, Inc., New York.

1. An inertial actuator assembly comprising an actuator chassis adapted to be secured in use to a structure subject in use to external vibration forces, a proof mass supported with respect to the chassis by a proof mass resilient means, and a force generating transducer means acting between the chassis and the proof mass for subjecting in use the proof mass to a force applied relative to the chassis, a controller arranged to control in use the excitation of the transducer means, characterized by a feedback means responsive to a measurement of the displacement of the proof mass relative to the chassis, the controller being arranged to modify the excitation of the force generating transducer means in response to a feedback signal from the feedback means.

2. An inertial actuator as claimed in claim 1 in which the measurement of displacement is provided by an internal displacement sensor.

3. An inertial actuator as claimed in claim 2 in which the internal displacement sensor is selected from the group: an electrostatic sensor; an electrical resistance sensor; a capacitive sensor; an inductive sensor; an optical sensor.

4. An inertial actuator as claimed in claim 3 in which the internal displacement sensor is a strain gauge.

5. An inertial actuator as claimed in any of claims 1 to 4 in which the feedback signal is proportional to the measurement of the displacement.

6. An inertial actuator as claimed in any of claims 1 to 4 in which the feedback signal is proportional to the integral of the measurement of the displacement.

7. An inertial actuator as claimed in any of claims 1 to 4 in which the feedback signal is proportional to the derivative of the measurement of the displacement.

8. An inertial actuator as claimed in any of claims 1 to 4 in which the feedback signal is any combination of a signal proportional to the displacement, a signal proportional to the integral of the displacement and a signal proportional to the derivative of the displacement.

9. An inertial actuator as claimed in claim 1 in which the actuator chassis comprises a casing.

10. An inertial actuator as claimed in claim 1 in which the force generating transducer means is selected from the group: an electromagnetic motor; a pneumatic motor; an electrostatic motor.

11. An inertial actuator as claimed in claim 9 in which the force generating transducer means comprises an electromagnetic motor.

12. An inertial actuator as claimed in claim 1 which comprises a temperature sensor.

13. An inertial actuator as claimed in claim 1 which comprises a stop mechanism adapted to restrict the motion of the proof mass relative to the chassis in the event of actuation control failure.

14. The use of an inertial actuator as claimed in claim 1 in which the inertial actuator is employed to improve the stability properties of another, outer, control system.
